(19) United States
(12) Patent Application Publication
(10) Pub. No.: US 2008/0099183 A1
(43) Pub. Date: May 1, 2008

(54) Aluminum Clad Steel Composite for Heat Exchanger Tubes and Manifolds

(75) Inventor: John Milnthorp, McMurray, PA (US)

Correspondence Address: THE WEBB LAW FIRM, P.C., 700 KOPPERS BUILDING, 436 SEVENTH AVENUE, PITTSBURGH, PA, 15219, US

(73) Assignee: ALL-CLAD METALCRAFTERS LLC, Canonsburg, PA (US)

(21) Appl. No.: 11/853,385

(22) Filed: Sep. 11, 2007

Related U.S. Application Data
(60) Provisional application No. 60/844,050, filed on Sep. 12, 2006.

(51) Int. Cl. B32B 15/01; B21D 39/06; F28F 7/00; B21D 53/02

(52) U.S. Cl. 165/77; 29/890.03; 29/890.043; 428/650

(57) ABSTRACT

A brazable composite metal material for a heat exchanger tube or manifold, a method of making the tube or manifold, and a heat exchanger made therefrom. The composite metal suitable for making the heat exchanger tube or manifold has one of an aluminized carbon steel, galvanized carbon steel, or steel wire mesh core roll bonded to at least one outer layer of a brazable aluminum alloy, such as type 3003 aluminum alloy. The method of making the heat exchanger tube includes the steps of (a) providing a core of one of an aluminized carbon steel, galvanized carbon steel, or steel wire mesh sheet or strip material; (b) placing at least one sheet or strip of brazable aluminum alloy material on the steel core; (c) roll bonding the aluminum alloy material to the aluminized surface of the steel core to form a roll bonded composite sheet or strip material; (d) forming the composite material to a desired configuration; and (e) joining abutting aluminum edges of the formed composite to form a fluid tight joined edge defining a shape having an open interior.

### CROSS-REFERENCE TO RELATED APPLICATION

This application claims the benefit of U.S. Provisional Application No. 60/844,050 filed Sep. 12, 2006, and is incorporated by reference herein in its entirety.

### BACKGROUND OF THE INVENTION

1. Field of the Invention

The present invention relates generally to heat exchanger tubes and manifolds or headers for fluid pressurized heat exchangers used in refrigeration units and, more particularly, to flat tube heat exchanger tubes and fabricated manifolds or headers made from composite metal sheets or coils.

2. Description of Related Art

Heretofore in the manufacture of heat exchanger tubes and manifolds or headers for heating, ventilating and air conditioning (HVAC) applications, it has been common practice to use aluminum alloy as the material of choice for the extruded tubes in the manufacture of parallel flat tube heat exchangers and for the round tubes forming the side manifolds or headers. Aluminum offers good formability, brazability, good thermal conduction, light weight and relatively low cost for this heat exchanger application. Recently, however, it has been found that when the Freon or other fluid heat transfer media used in the heat exchanger is replaced and run at higher operating pressures, the conventional seamless, extruded flat aluminum heat exchanger tubes and manifolds tend to swell or balloon, causing a malfunction of the heat exchanger. It has, therefore, been observed that the conventional extruded flat tubes and manifolds made from a brazable aluminum alloy do not possess sufficient strength to resist elastic deformation caused by the interior fluid pressure. The heat exchanger tubes and manifolds or headers of the present invention are intended to replace the flat all-aluminum heat exchanger tubes and round manifold or header tubes known in the art by providing a stronger composite material that is capable of withstanding higher fluid pressures and brazability, all at a reasonable cost.

### SUMMARY OF THE INVENTION

The present invention overcomes the ballooning problems occurring in the prior art all-aluminum heat exchanger tubes and manifolds or headers (hereinafter referred to collectively as a manifold) by providing a composite heat exchanger tube which can be easily formed and joined and which can withstand the higher Freon pressures without ballooning. Briefly stated, the present invention is directed to a flat heat exchanger tube or manifold made from a composite metal comprising a steel core roll bonded to one or two layers of aluminum alloy. The composite metal sheet is preferably made by using a core of an aluminized carbon steel sheet, i.e., a carbon steel sheet that is hot dipped in aluminum alloy, such as a silicon aluminum alloy, so that a thin coating of the silicon aluminum alloy is applied to one or both sides of the carbon steel sheet, hereinafter referred to as “aluminized carbon steel sheet”. This aluminized carbon steel sheet product is readily available commercially and at a reasonable cost. The core of aluminized carbon steel sheet is then roll bonded between layers of aluminum alloy such as type 3003 aluminum alloy (or other aluminum alloy that is suitable for brazing) at a total reduction of about 15% in several rolling passes conducted at about 600° F. As an alternative construction, a galvanized carbon steel sheet could also be used as a core material in the composite sheet.

In another presently preferred embodiment of the invention, the core of the composite metal may be galvanized carbon steel or a mesh or screen of carbon steel or stainless steel roll bonded to one or two layers of brazable aluminum alloy sheet.

The roll bonded composite sheet is then formed by bending into the desired heat exchanger or manifold tube shape, such as a flat tube or rectangular manifold, for example. The flat tube is in a generally rectangular shape in cross-section, obtained by bending the composite sheet 180° upon itself and then brazing the opposed edges of the aluminum alloy together to form a pressure tight conduit for a pressurized fluid such as Freon or other heat transfer fluid media. The manifold may be formed by bending the composite sheet in a series of 90° bends to form a four-sided rectangular or square shape in cross-section with closed ends. The manifold has a plurality of slots formed through one face thereof to receive the open ends of the heat exchanger tubes therein for subsequent brazing to form a fluid tight joint.

### BRIEF DESCRIPTION OF THE DRAWINGS

FIG. 1 is a cross-sectional schematic drawing of the sheets of material used to form the composite sheet prior to bonding according to the present invention;

FIG. 2 is a cross-sectional schematic drawing of the composite material being roll bonded according to the present invention;

FIG. 3 is a plan view of a flat heat exchanger tube of the present invention;

FIG. 4 is a cross-sectional view of the heat exchanger tube of FIG. 3, taken along section line V-V thereof;

FIG. 4A is an enlarged detail of the joined edge structure of FIG. 4;

FIG. 5 is a perspective view of a manifold tube of the present invention; and

FIG. 6 is a plan view of a stamped blank for use in forming the manifold tube of FIG. 5.

### DETAILED DESCRIPTION OF THE INVENTION

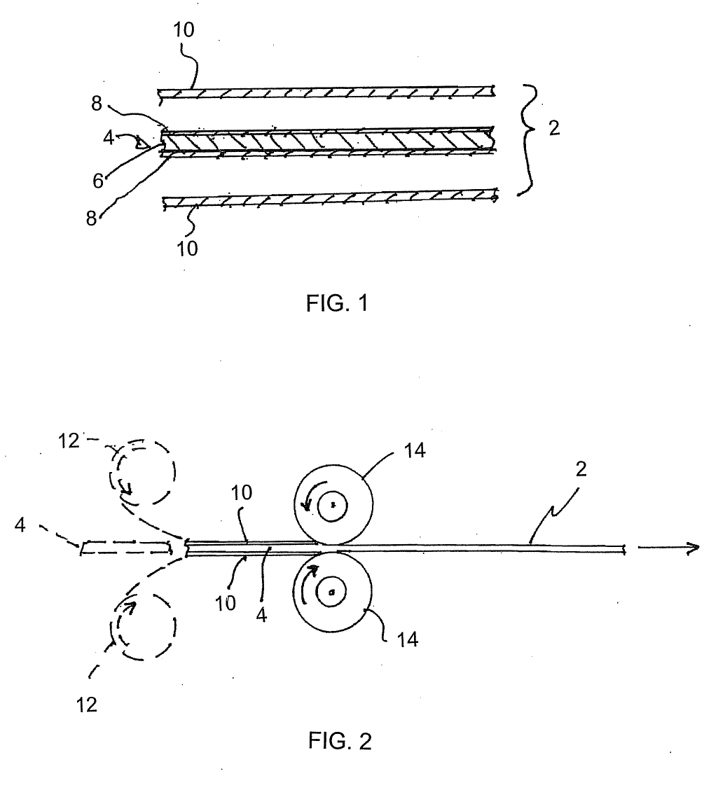

Referring now to the drawings, FIG. 1 depicts an exploded view of the three layers of metals that make up the composite material 2 of the present invention. The central or core layer 4 is an aluminized strip of carbon steel comprising a carbon steel inner portion 6 covered on both sides with a hot dipped aluminum coating 8 of aluminum. The aluminized carbon steel layer 4 is commercially available from many sources and is made according to ASTM Specification A463 Type A. I prefer to use a starting thickness of 0.080 inch (2 mm) for the core layer 4 in making the composite sheet 2.

The core layer 4 of aluminized carbon steel has layers 10 of aluminum alloy roll bonded to opposed sides thereof. Each of the aluminum alloy layers 10 are preferably type 3003 aluminum alloy, each layer 10 having a starting minimum thickness of about 0.040 inch. As mentioned above, however, another aluminum alloy, other than type 3003, that has good brazing characteristics may also be used as layer 10. The stock for forming the roll bonded composite material 2 may be in sheet form or in coil form. As shown in phantom lines in FIG. 2, the aluminum alloy layers 10 may be supplied in coils 12. In certain applications, it is also desired to roll bond only one layer 10 of aluminum alloy to the aluminized carbon steel layer 4 as a stack pack to form a two-layer composite for making the heat exchanger tubes.

Prior to roll bonding, the facing surfaces of the materials to be bonded, namely, the aluminized carbon steel core 4 and the aluminum alloy layers 10, are cleaned to remove grease and dirt and then mechanically abraded to remove oxide layers on their facing surfaces.

The three layers shown in FIG. 1, namely, the aluminized carbon steel core 4, and two aluminum layers 10 are preheated to about 600° F. in a regular air atmosphere furnace and then rolled between the rolls 14 of a rolling mill shown in FIG. 2. A first rolling pass is made at a light reduction of about 2% and then a second, final rolling pass is made at a greater reduction of about 13%. The final rolled thickness of the composite material 2 is presently preferred at about 0.136 inch. The thickness can, of course, be varied according to the final mechanical strength required in the heat exchanger.

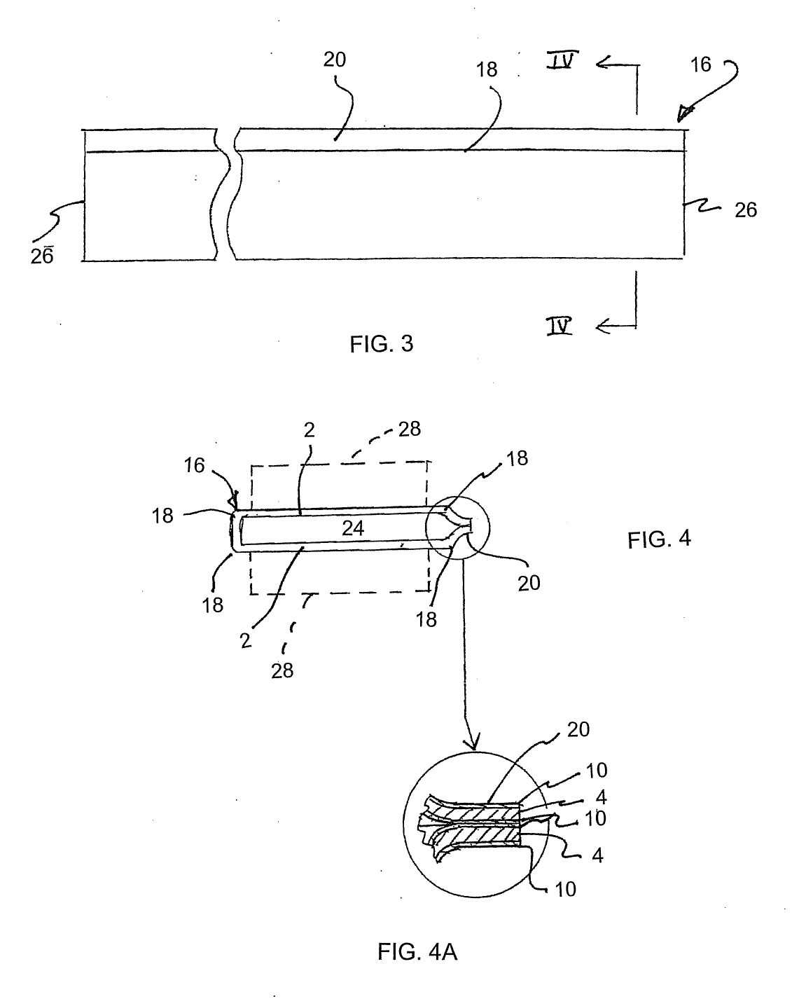

The roll bonded composite material 2 is then formed by bending to the desired configuration of a flat tube heat exchanger tube 16 shown in FIGS. 3-4. The composite sheet 2 is bent in a break press, for example, with 90° bends at the corners 18, with a flange 20 formed at the edges. The overlaying flanges 20 may then be joined by brazing at flange interface 22 at about 1000° F. to form a flat heat exchanger tube 16 having an open interior 24 shown in FIG. 4 for the flow of pressurized refrigerant fluid such as Freon therethrough.

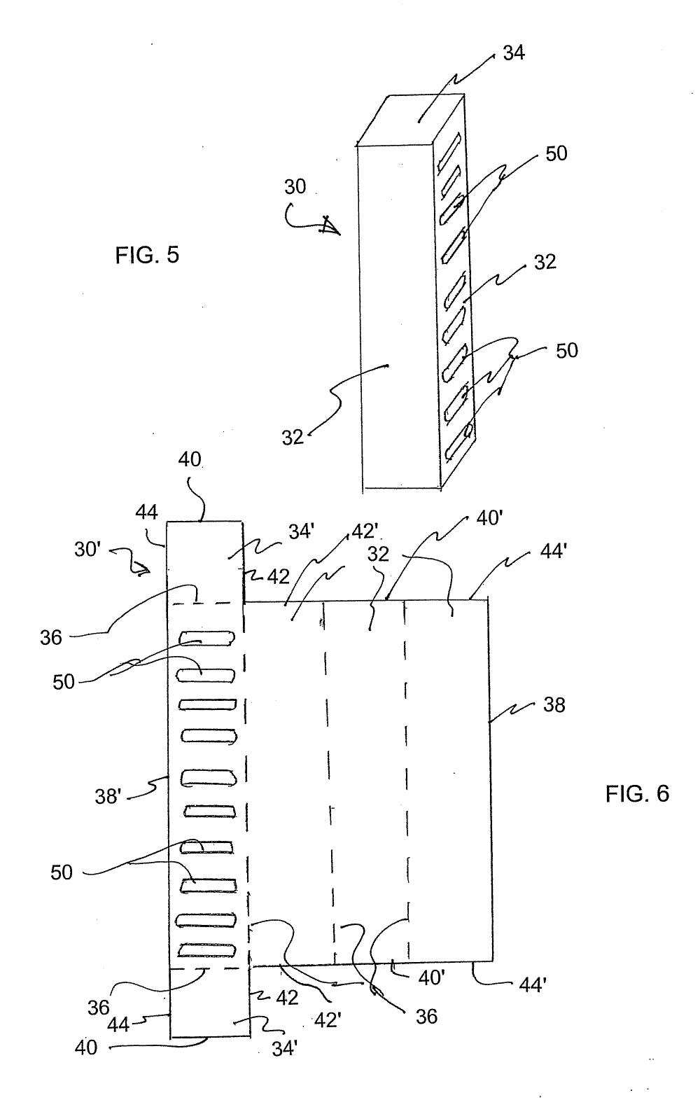

The open ends 26 of the flat heat exchanger tube 16 are joined by brazing to hollow manifolds (shown in FIGS. 5 and 6) and a plurality of spaced-apart tubes 16 are joined in like manner to the manifolds to form a heat exchanger module along with heat exchanger fins 28 shown schematically in FIG. 4. The hollow manifold members would have a plurality of spaced-apart rectangularly shaped openings formed therein to receive the open ends 26 of the heat exchanger tubes and allow fluid communication between the open interior 24 of the heat exchanger tube and the interior of the hollow manifold member, in a known manner. The heat exchanger fins 28 are per se known in the art and are also made from a brazable aluminum alloy. The fins 28 are also brazed to the tubes 16 at the surfaces of aluminum alloy layers 10 thereof to increase the surface area of the heat exchanger module for heat transfer purposes.

As an alternate embodiment of the present invention, the steel core 4 of the composite material 2 can be a mesh or screen-like layer of carbon steel or stainless steel. The mesh steel core 4 is then roll bonded to the brazable aluminum alloy layer or layers 10. By way of example, the wire screen or mesh material employed as steel core 4 may have a wire thickness of about 0.010 inches, with a screen mesh of about 28 wires per inch. When roll bonded, the layers 10 of aluminum alloy material will bond to adjacent surfaces as they are forcibly engaged through the openings in steel screen material. A steel core 4 of a wire mesh or screen will provide additional strength with less weight than a solid core of steel.

A manifold 30 made in accordance with the present invention is shown in FIGS. 5 and 6. The formed manifold 30 is depicted in FIG. 5 and the metal blank 30′ for forming the manifold 30 is shown in FIG. 6. The blank 30′ is stamped from a sheet or strip of the composite metal 2 of the present invention, preferably having a core 4 of aluminized carbon steel, roll bonded between layers 10 of aluminum alloy such as 3003 aluminum alloy as previously described with respect to FIGS. 1 and 2.

The manifold 30 of FIG. 5 comprises four elongated side panels 32 and two end panels 34, the corresponding parts of which are identified in like primed numbers in FIG. 6. The rectangularly shaped, box-like structure of manifold 30 is formed by bending the composite metal of the stamped blank 30′ along the fold lines 36. The blank is bent at 90° angles at the fold lines 36 to form the enclosed shape of the manifold 30 wherein metal edges 38-38′ are joined; metal edges 40 and 40′ are joined; edges 42 and 42′ are joined; and edges 44 and 44′ are joined. The aforesaid joined edges of the blank 30′ may be secured by welding or brazing.

A plurality of slots 50 are punched out, preferably during the stamping operation which forms the blank 30′. The slots 50 are formed of a desired size and configuration to receive the open end portions of the heat exchanger tubes 16 of the present invention or heat exchanger tubes of a different construction, such as extruded multi-port tubes (MPE tubes), known in the heat exchanger art. The heat exchanger tubes (and fins) can then be oven brazed to the manifolds 30 as previously described.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A brazable roll bonded composite metal sheet having a steel core roll bonded to at least one layer of aluminum suitable for making heat exchanger tubes.

2. The composite metal sheet of claim 1 wherein the steel core is one of an aluminized carbon steel, a galvanized carbon steel, or a steel wire mesh and the aluminum of the outer layer is a brazable aluminum alloy.

3. The composite metal sheet of claim 2 wherein the brazable aluminum alloy is type 3003 aluminum alloy.

4. The composite metal sheet of claim 3 wherein a starting thickness of the aluminized carbon steel core is about 0.080 inch and the minimum starting thickness of each of the aluminum alloy is about 0.040 inch prior to roll bonding and a finish thickness of the roll bonded composite sheet is at least about 0.136 inch.

5. A heat exchanger tube having a rectangularly-shaped cross-section with a joined flange on one side made from the roll-bonded composite sheet of claim 1.

6. A method of making a heat exchanger tube or manifold comprising the steps of:
(a) providing a core layer comprising one of an aluminized carbon steel, a galvanized carbon steel, or a steel wire mesh sheet or strip material;
(b) placing a sheet or strip of a brazable aluminum alloy material on one or both sides of the core layer;
(c) roll bonding the aluminum alloy material to the core layer to form a roll bonded composite sheet or strip material;
(d) forming the composite material to a desired configuration; and
(e) joining abutting edges of the aluminum alloy in the formed composite to form a fluid tight joined edge defining a shape having an open interior.

7. The method of claim 6 wherein the joining step (e) is by one of brazing or welding.

8. The method of claim 6 wherein the manifold has a substantially rectangular or square configuration in cross-section.

9. The method of making a heat exchanger tube of claim 6 including the steps of removing surface oxides from the aluminized carbon steel or galvanized carbon steel material and from the aluminum alloy material and heating said materials prior to roll bonding step (c).

10. The method of claim 9 wherein the heating step is conducted at about 600° F.±50° F. in an ambient atmosphere.

11. The method of claim 6 wherein the roll bonding step is conducted with a preheated stacked array of aluminum alloy sheet or strip facing the aluminized carbon steel or galvanized carbon steel, and the roll bonding reduces the stacked array a total of about 15%.

12. The method of claim 11 wherein the roll bonding is conducted in a rolling mill in at least two passes through said mill.

13. The method of claim 12 wherein the roll bonding is conducted in two passes, wherein the first pass is at about a 2% reduction and the second pass is at about a 13% reduction.

14. A method of making a heat exchanger comprising the steps of:
(a) providing a plurality of heat exchanger tubes and manifold members made according to the method of claim 6;
(b) assembling the heat exchanger tubes with the manifold members, wherein the manifold members have a plurality of cut-out portions to receive open ends of the heat exchanger tubes therein, whereby the manifold members are in fluid communication with the heat exchanger tubes; and
(c) joining the heat exchanger tubes to the manifold members by brazing.

15. The method of claim 14 including the steps of providing a plurality of heat exchanger fins; and joining said fins to and between adjacent heat exchanger tubes.

16. A heat exchanger manifold comprising a roll bonded metal sheet having an aluminized carbon steel core roll bonded between two layers of a brazable aluminum alloy.

17. The heat exchanger manifold of claim 16 wherein the aluminum alloy is type 3003 aluminum alloy.
